(19) United States
(12) Patent Application Publication
(10) Pub. No.: US 2018/0055234 A1
(43) Pub. Date: Mar. 1, 2018

(54) Bed Leveling System

(71) Applicant: Peggy Strater, Laurel Springs, NJ (US)

(72) Inventor: Peggy Strater, Laurel Springs, NJ (US)

(21) Appl. No.: 15/247,553

(22) Filed: Aug. 25, 2016

(51) Int. Cl. A47C 17/80; A47C 17/86; B62D 33/06; B60P 3/38

(52) U.S. Cl. CPC A47C 17/80; B60P 3/38; B62D 33/0612; A47C 17/86

(57) ABSTRACT

A bed leveling system includes a vehicle that has a sleeper. A bed is positioned within the sleeper and the bed is slept upon. A leveling unit is positioned within the sleeper. The leveling unit is selectively positioned at a selected angle with respect to Earth. Thus, the leveling unit may be leveled. The bed is positioned on the leveling unit to enhance comfort while sleeping. A control is coupled to the leveling unit and the control may be manipulated. The control is electrically coupled to the leveling unit and the control controls operational parameters of the leveling unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to leveling devices and more particularly pertains to a new leveling device for leveling a bed in a vehicle sleeper.

### BRIEF SUMMARY OF THE INVENTION

An embodiment of the disclosure meets the needs presented above by generally comprising a vehicle that has a sleeper. A bed is positioned within the sleeper and the bed is slept upon. A leveling unit is positioned within the sleeper. The leveling unit is selectively positioned at a selected angle with respect to Earth. Thus, the leveling unit may be leveled. The bed is positioned on the leveling unit to enhance comfort while sleeping. A control is coupled to the leveling unit and the control may be manipulated. The control is electrically coupled to the leveling unit and the control controls operational parameters of the leveling unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a bed leveling system according to an embodiment of the disclosure.

FIG. 2 is a cross sectional view taken along line 2-2 of FIG. 1 of an embodiment of the disclosure.

FIG. 3 is a cross sectional view taken along line 3-3 of FIG. 1 of an embodiment of the disclosure.

FIG. 4 is a top phantom view of an embodiment of the disclosure.

FIG. 5 is a perspective in-use view of an embodiment of the disclosure.

### DETAILED DESCRIPTION OF THE INVENTION

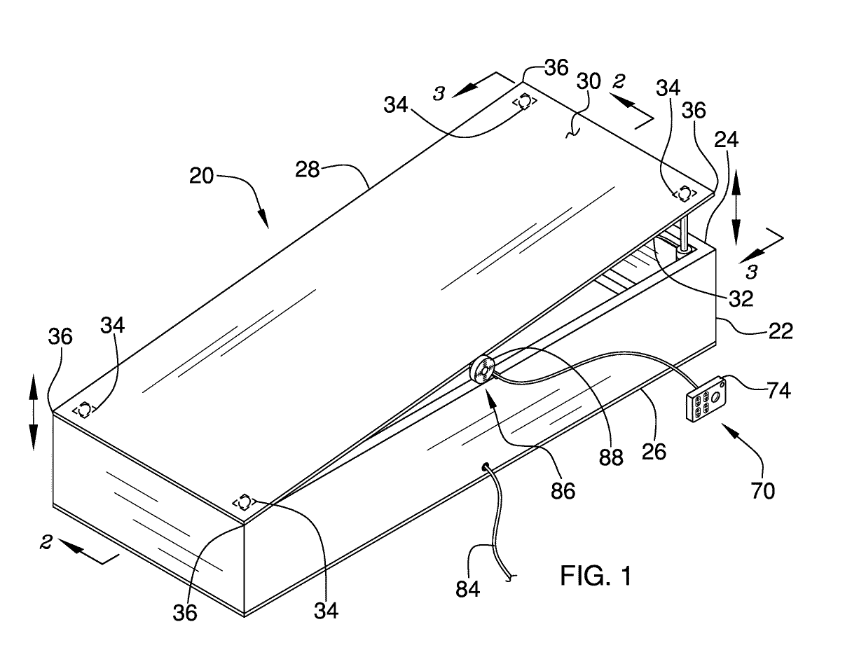

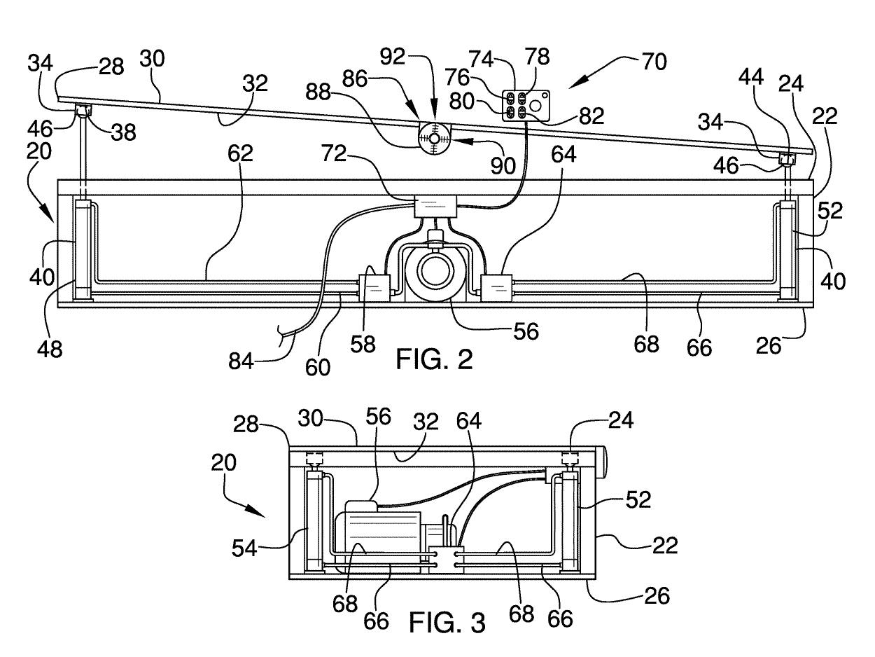

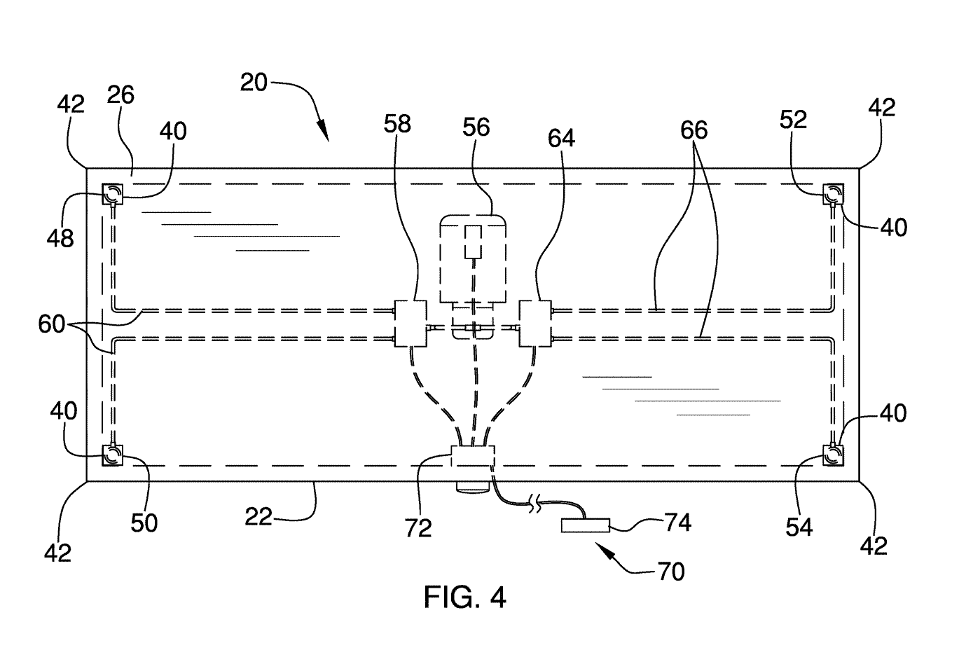

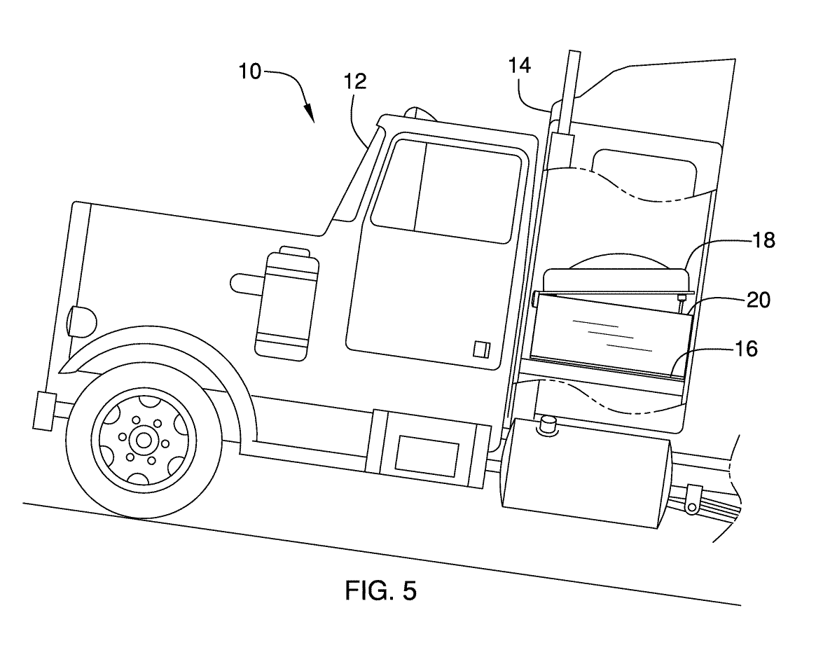

With reference now to the drawings, and in particular to FIGS. 1 through 5 thereof, a new leveling device embodying the principles and concepts of an embodiment of the disclosure and generally designated by the reference numeral 10 will be described.

As best illustrated in FIGS. 1 through 5, the bed leveling system 10 generally comprises a vehicle 12 that has a sleeper 14. The sleeper 14 has a basal wall 16. The vehicle 12 may be a semi tractor or the like. A bed 18 is positioned within the sleeper 14 and the bed 18 may be slept upon.

A leveling unit 20 is positioned within the sleeper 14. The leveling unit 20 is selectively positioned at a selected angle with respect to Earth. Thus, the leveling unit 20 may be leveled and the bed 18 is positioned on the leveling unit 20. The leveling unit 20 enhances comfort while sleeping.

The leveling unit 20 comprises a box 22 that has a top side 24 and a bottom side 26. The top side 24 is open to access an interior of the box 22. The bottom side 26 is positioned on the basal wall 16 of the sleeper 14. A panel 28 is provided that has a top surface 30 and a bottom surface 32. The bottom surface 32 abuts the top side 24 of the box 22 and the bed 18 is positioned on the top surface 30.

A plurality of cups 34 is provided. Each of the cups 34 is coupled to the bottom surface 32 of the panel 28. Each of the cups 34 is positioned adjacent to an associated one of four corners 36 of the panel 28. Each of the cups 34 has a distal surface 38 with respect to the bottom surface 32 of the panel 28. The distal surface 38 corresponding to each of the cups 34 is concavely arcuate with respect to the bottom surface 32 of the panel 28.

A plurality of pistons 40 is provided. Each of the pistons 40 is coupled to and extends upwardly from the bottom side 26 of the box 22. Each of the pistons 40 is positioned at an associated one of four corners 42 of the box 22. Each of the pistons 40 has a distal end 44 with respect to the bottom side 26 of the box 22.

A ball 46 is coupled to the distal end 44 of each of the pistons 40. The ball 46 corresponding to each of the pistons 40 is rotatably coupled to an associated one of the cups 34. The ball 46 frictionally engages the distal surface 38 of the associated cup. Thus, the ball 46 rolls freely within the associated cup 34. Each of the pistons 40 may be a hydraulic piston or the like. The plurality of pistons 40 includes a first piston 48, a second piston 50, a third piston 52 and a fourth piston 54.

A pump 56 is provided. The pump 56 is positioned within the box 22. The pump 56 may comprise a hydraulic pump 56 or the like. Moreover, the pump 56 is electrically controlled.

A first manifold 58 is provided and the first manifold 58 is positioned within the box 22. The first manifold 58 contains a hydraulic fluid. The first manifold 58 is fluidly coupled to the pump 56. The first manifold 58 may comprise an electrically controlled hydraulic manifold or the like.

A pair of first output lines 60 is provided. Each of the first output lines 60 is fluidly coupled between the first manifold 58 and an associated one of the first piston 48 and the second piston 50. Thus, the pump 56 selectively urges the hydraulic fluid through each of the first output lines 60. A pair of first return lines 62 is provided. Each of the first return lines 62 is fluidly coupled between the first manifold 58 and an associated one of the first piston 48 and the second piston 50. Thus, the pump 56 selectively draws the hydraulic fluid through each of the first return lines 62.

A second manifold 64 is provided and the second manifold 64 is positioned within the box 22. The second manifold 64 contains a hydraulic fluid. The second manifold 64 is fluidly coupled to the pump 56. The second manifold 64 may comprise an electrically controlled hydraulic manifold or the like. The hydraulic fluid may comprise hydraulic oil or the like.

A pair of second output lines 66 is provided. Each of the second output lines 66 is fluidly coupled between the second manifold 64 and an associated one of the third piston 52 and the fourth piston 54. Thus, the pump 56 selectively urges the hydraulic fluid through each of the second output lines 66. A pair of second return lines 68 is provided. Each of the second return lines 68 is fluidly coupled between the second manifold 64 and an associated one of the third piston 52 and the fourth piston 54. Thus, the pump 56 selectively draws the hydraulic fluid through each of the second return lines 68.

A control 70 is provided. The control 70 is coupled to the leveling unit 20 and the control 70 may be manipulated. The control 70 is electrically coupled to the leveling unit 20. Thus, the control 70 controls operational parameters of the leveling unit 20.

The control 70 comprises a switch 72 that is coupled to the box 22. The switch 72 is electrically coupled to each of the first manifold 58, the second manifold 64 and the pump 56. The switch 72 may be a hydraulic control switch or the like. The switch 72 selectively actuates the pump 56, the first manifold 58 and the second manifold 64.

A remote control 74 is provided and the remote control 74 may be manipulated. The remote control 74 is electrically coupled to the switch 72. The remote control 74 has a first button 76, a second button 78, a third button 80 and a fourth button 82. Each of the first button 76, the second button 78, the third button 80 and the fourth button 82 may be positioned in an up position and a down position.

The first button 76 actuates the first piston 48 to selectively urge the panel 28 upwardly with respect to the box 22 when the first button 76 is positioned in the up position. The first button 76 actuates the first piston 48 to urge the panel 28 downwardly with respect to the box 22 when the first button 76 is positioned in the down position. The second button 78 actuates the second piston 50 to selectively urge the panel 28 upwardly with respect to the box 22 when the second button 78 is positioned in the up position. The second button 78 actuates the second piston 50 to selectively urge the panel 28 downwardly with respect to the box 22 when the second switch 72 is in the down position.

The third button 80 actuates the third piston 52 to selectively urge the panel 28 upwardly with respect to the box 22 when the third button 80 is positioned in the down position. The third button 80 actuates the third piston 52 to urge the panel 28 downwardly with respect to the box 22 when the third button 80 is in the down position. The fourth button 82 actuates the fourth piston 54 to selectively urge the panel 28 upwardly with respect to the box 22 when the fourth button 82 is in the up position. The fourth button 82 actuates the fourth piston 54 to urge the panel 28 downwardly with respect to the box 22 when the fourth button 82 is in the down position.

A power cord 84 is provided. The power cord 84 is electrically coupled to and extends outwardly from the switch 72. The power cord 84 is electrically coupled to the vehicle 12. The power cord 84 may be electrically coupled to the vehicle 12's electrical system.

A bubble level 86 is provided and the bubble level 86 is coupled to the panel 28. Thus, the bubble level 86 may display an orientation of the panel 28 with respect to Earth. The bubble level 86 includes a disk 88 that has an X-axis 90 and a Y-axis 92. The X-axis 90 displays a level of the panel 28 with respect to an axis extending longitudinally through the panel 28. The Y-axis 92 displays a level of the panel 28 with respect to an axis extending laterally through the panel 28.

In use, the remote control 74 is manipulated to selectively actuate each of the first piston 48, the second piston 50, the third piston 52 and the fourth piston 54. Thus, the leveling unit 20 levels the panel 28 with respect to the X-axis 90 and the Y-axis 92. The panel 28 facilitates the bed 18 to be positioned level when the vehicle 12 is parked on an incline or the like. Thus, the leveling unit 20 enhances comfort of the bed 18.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bed leveling system comprising:
a vehicle having a sleeper;
a bed being positioned within said sleeper wherein said bed is configured to be slept upon;
a leveling unit being positioned within said sleeper, said leveling unit being selectively positioned at a selected angle with respect to Earth wherein said leveling unit is configured to be leveled, said bed being positioned on said leveling unit wherein said leveling unit is configured to enhance comfort while sleeping; and
a control being coupled to said leveling unit wherein said control is configured to be manipulated, said control being electrically coupled to said leveling unit such that said control controls operational parameters of said leveling unit.

2. The system according to claim 1, wherein:
said sleeper has a basal wall; and
said leveling unit comprises a box having a top side and a bottom side, said top side being open to access an interior of said box, said bottom side being positioned on said basal wall of said sleeper.

3. The system according to claim 2, further comprising a panel having a top surface and a bottom surface, said bottom surface abutting said top side of said box, said bed being positioned on said top surface.

4. The system according to claim 3, further comprising a plurality of cups, each of said cups being coupled to said bottom surface of said panel, each of said cups being positioned adjacent to an associated one of four corners of said panel.

5. The system according to claim 2, further comprising a plurality of pistons, each of said pistons being coupled to and extending upwardly from said bottom side of said box, each of said pistons being positioned at an associated one of four corners of said box, each of said pistons having a distal end with respect to said bottom side of said box.

6. The system according to claim 5, wherein:
said leveling unit includes:
a panel having a bottom surface, and
a plurality of cups, each of said cups being coupled to said bottom surface; and
each of said pistons includes a ball being coupled to said distal end of an associated one of said pistons, said ball corresponding to each of said pistons being rotatably coupled to an associated one of said cups, said plurality of pistons including a first piston, a second piston, a third piston and a fourth piston.

7. The system according to claim 2, further comprising a pump being positioned within said box.

8. The system according to claim 7, further comprising a first manifold being configured to contain a hydraulic fluid, said first manifold being fluidly coupled to said pump.

9. The system according to claim 8, further comprising:
a first piston;
a second piston;
a pair of first output lines, each of said first output lines being fluidly coupled between said first manifold and an associated one of said first piston and said second piston wherein said pump is configured to selectively urge the hydraulic fluid through each of said first output lines; and
a pair of first return lines, each of said first return lines being fluidly coupled between said first manifold and an associated one of said first piston and said second piston wherein said pump is configured to selectively draw the hydraulic fluid through each of said first return lines.

10. The system according to claim 7, further comprising a second manifold being configured to contain a hydraulic fluid, said second manifold being fluidly coupled to said pump.

11. The system according to claim 10, further comprising:
a third piston;
a fourth piston;
a pair of second output lines, each of said second output lines being fluidly coupled between said second manifold and an associated one of said third piston and said fourth piston wherein said pump is configured to selectively urge the hydraulic fluid through each of said second output lines; and
a pair of second return lines, each of said second return lines being fluidly coupled between said second manifold and an associated one of said third piston and said fourth piston wherein said pump is configured to selectively draw the hydraulic fluid through each of said second return lines.

12. The system according to claim 1, wherein:
said leveling unit comprises:
a box,
a pump,
a first manifold, and
a second manifold; and
said control comprises a switch being coupled to said box, said switch being electrically coupled to each of said first manifold, said second manifold and said pump.

13. The system according to claim 12, further comprising:
a box;
a first piston;
a second piston;
a third piston;
a fourth piston; and
a remote control being configured to be manipulated, said remote control being electrically coupled to said switch, said remote control having a first button, a second button, a third button and a fourth button, said first button actuating said first piston to selectively urge said panel upwardly and downwardly with respect to said box, said second button actuating said second piston to selectively urge said panel upwardly and downwardly with respect to said box, said third button actuating said third piston to selectively urge said panel upwardly and downwardly with respect to said box, said fourth button actuating said fourth piston to selectively urge said panel upwardly and downwardly with respect to said box.

14. The system according to claim 12, further comprising a power cord being electrically coupled to and extending outwardly from said switch, said power cord being electrically coupled to said vehicle.

15. The system according to claim 1, further comprising:
a panel; and
a bubble level being coupled to said panel wherein said bubble level is configured to display an orientation of said panel with respect to Earth.

16. The system according to claim 15, wherein said bubble level includes a disk having an X-axis and a Y-axis, said X-axis being configured to display a level of said panel with respect to an axis extending longitudinally through said panel, said Y-axis being configured to display a level of said panel with respect to an axis extending laterally through said panel.

17. The system according to claim 16, wherein:
said leveling unit comprises:
a first piston,
a second piston,
a third piston, and
a fourth piston; and
said remote control being manipulated to selectively actuate each of said first piston, said second piston, said third piston and said fourth piston wherein said leveling unit is configured to level said panel with respect to said X-axis and said Y-axis.

18. A bed leveling system comprising:
a vehicle having a sleeper, said sleeper having a basal wall;
a bed being positioned within said sleeper wherein said bed is configured to be slept upon;
a leveling unit being positioned within said sleeper, said leveling unit being selectively positioned at a selected angle with respect to Earth wherein said leveling unit is configured to be leveled, said bed being positioned on said leveling unit wherein said leveling unit is configured to enhance comfort while sleeping, said leveling unit comprising:
a box having a top side and a bottom side, said top side being open to access an interior of said box, said bottom side being positioned on said basal wall of said sleeper,
a panel having a top surface and a bottom surface, said bottom surface abutting said top side of said box, said bed being positioned on said top surface,
a plurality of cups, each of said cups being coupled to said bottom surface of said panel, each of said cups being positioned adjacent to an associated one of four corners of said panel,
a plurality of pistons, each of said pistons being coupled to and extending upwardly from said bottom side of said box, each of said pistons being positioned at an associated one of four corners of said box, each of said pistons having a distal end with respect to said bottom side of said box, each of said pistons including a ball being coupled to said distal end of an associated one of said pistons, said ball corresponding to each of said pistons being rotatably coupled to an associated one of said cups, said plurality of pistons including a first piston, a second piston, a third piston and a fourth piston,
a pump being positioned within said box,
a first manifold being configured to contain a hydraulic fluid, said first manifold being fluidly coupled to said pump,
a pair of first output lines, each of said first output lines being fluidly coupled between said first manifold and an associated one of said first piston and said second piston wherein said pump is configured to selectively urge the hydraulic fluid through each of said first output lines,
a pair of first return lines, each of said first return lines being fluidly coupled between said first manifold and an associated one of said first piston and said second piston wherein said pump is configured to selectively draw the hydraulic fluid through each of said first return lines,
a second manifold being configured to contain a hydraulic fluid, said second manifold being fluidly coupled to said pump,
a pair of second output lines, each of said second output lines being fluidly coupled between said second manifold and an associated one of said third piston and said fourth piston wherein said pump is configured to selectively urge the hydraulic fluid through each of said second output lines,
a pair of second return lines, each of said second return lines being fluidly coupled between said second manifold and an associated one of said third piston and said fourth piston wherein said pump is configured to selectively draw the hydraulic fluid through each of said second return lines; and
a control being coupled to said leveling unit wherein said control is configured to be manipulated, said control being electrically coupled to said leveling unit such that said control controls operational parameters of said leveling unit, said control comprising:
a switch being coupled to said box, said switch being electrically coupled to each of said first manifold, said second manifold and said pump,
a remote control being configured to be manipulated, said remote control being electrically coupled to said switch, said remote control having a first button, a second button, a third button and a fourth button, said first button actuating said first piston to selectively urge said panel upwardly and downwardly with respect to said box, said second button actuating said second piston to selectively urge said panel upwardly and downwardly with respect to said box, said third button actuating said third piston to selectively urge said panel upwardly and downwardly with respect to said box, said fourth button actuating said fourth piston to selectively urge said panel upwardly and downwardly with respect to said box, and
a power cord being electrically coupled to and extending outwardly from said switch, said power cord being electrically coupled to said vehicle; and
a bubble level being coupled to said panel wherein said bubble level is configured to display an orientation of said panel with respect to Earth, said bubble level including a disk having an X-axis and a Y-axis, said X-axis being configured to display a level of said panel with respect to an axis extending longitudinally through said panel, said Y-axis being configured to display a level of said panel with respect to an axis extending laterally through said panel, said remote control being manipulated to selectively actuate each of said first piston, said second piston, said third piston and said fourth piston wherein said leveling unit is configured to level said panel with respect to said X-axis and said Y-axis.
